(19) United States
(12) Patent Application Publication
(10) Pub. No.: US 2014/0351001 A1
(43) Pub. Date: Nov. 27, 2014

(54) BUSINESS ENTERPRISE SALES AND OPERATIONS PLANNING THROUGH A BIG DATA AND BIG MEMORY COMPUTATIONAL ARCHITECTURE

(71) Applicants: Chandra P. Agrawal, Pleasanton, CA (US); Glen William Margolis, Danville, CA (US)

(72) Inventors: Chandra P. Agrawal, Pleasanton, CA (US); Glen William Margolis, Danville, CA (US)

(21) Appl. No.: 13/899,595

(22) Filed: May 22, 2013

(51) Int. Cl. G06Q 30/02

(52) U.S. Cl. CPC G06Q 30/0201
USPC 705/7.29

(57) ABSTRACT

Disclosed are methods, devices, and systems to provide sales and operations planning (S&OP) for a business enterprise. In one embodiment, a machine-implemented method includes aggregating a S&OP raw data by one or more relational database management systems (RDBMS) communicatively coupled to a big data computation engine; performing a S&OP simulation, by one or more processing nodes of the big data computation engine, using the S&OP raw data; caching a result of the S&OP simulation in a big memory cache communicatively coupled to the big data computation engine; and edge caching the result of the S&OP simulation in an edge cache server near a geographical point of origin of the S&OP raw data. The S&OP raw data may be a historical or forward-looking data input from an ERP program, a CRM program, an SRM program, an MRP program, an SKU database, or a user client device.

### FIELD OF TECHNOLOGY

This disclosure relates generally to a sales and operations planning platform, in one example embodiment, to a method, system, and device of sales and operations planning for a business enterprise.

### BACKGROUND

Sales and operations planning (S&OP) is a recurring business process where plans for both customer expectations and internal operations are reviewed by managers of the business for accuracy, accountability, and risk management purposes. Historical data, future forecasts, and short-term realities are taken into consideration when performing this review. While traditional S&OP planning cycles are usually implemented on a month-by-month basis, today's volatile global marketplace has eroded the effectiveness of such monthly processes. Gone are the days of rigid business plans and fine-tuned demand forecasts. A high-performing enterprise trying to succeed in this volatile marketplace must have the capability to plan at a monthly level and also re-plan at ad-hoc frequencies with the involvement of relevant business units.

While an off-the-shelf spreadsheet application loaded on a personal computer may have been sufficient in handling the S&OP needs of a company in years past, today's enterprises require technology solutions that can handle data volumes far in excess of what was once thought possible. For example, today's business enterprise may rely on internal and external supply chains that create data combinations running into the millions and, possibly, into the billions. Moreover, a standalone spreadsheet on one computer may not be accessible to numerous on-the-ground sales managers, finance planners, and high-level executives resident in different locations around the globe. Finally, a standalone spreadsheet application may not be compatible with existing customer relations management (CRM) or enterprise resource planning (ERP) solutions that contain much of the raw data needed to craft an effective S&OP plan.

In addition, an enterprise undertaking S&OP in the highly competitive business enterprise may face unique planning challenges. Therefore, it would be desirable to have an S&OP solution that is both agile and powerful enough to perform large scale calculations and simulations in a short amount of time.

### SUMMARY

Disclosed are methods, devices, and systems providing sales and operations planning (S&OP) of a business enterprise. In one aspect, a machine-implemented method includes: aggregating a S&OP raw data by one or more relational database management systems (RDBMS) communicatively coupled to a big data computation engine; performing a S&OP simulation, by one or more processing nodes of the big data computation engine, using the S&OP raw data; caching a result of the S&OP simulation in a big memory cache communicatively coupled to the big data computation engine; and edge caching the result of the S&OP simulation in an edge cache server near a geographical point of origin of the S&OP raw data. The S&OP raw data may be a historical or forward-looking data input from at least one of an enterprise resource planning (ERP) program, a customer relationship management (CRM) program, a supplier relationship management (SRM) program, a material resource planning (MRP) program, a stock-keeping unit (SKU) database, and a user client device.

The method may also involve displaying the result of the S&OP simulation cached in the edge cache server through a plug-in interface of an off-the-shelf spreadsheet program. The method may involve displaying the result of the S&OP simulation cached in the edge cache server through a web-based spreadsheet program. The method may also involve accelerating the edge caching of the result by a toll route of data transmission. The method may additionally involve collecting the S&OP raw data by the one or more storage devices of the big data computation engine and the one or more RDBMS and storing the S&OP raw data in a columnar database table distributed across at least one of one or more memory storage devices of the big data computation engine, the one or more RDBMS, and the big memory cache.

The S&OP simulation may involve modeling a historical or forward-looking profitability of the business enterprise using the S&OP raw data; modeling a demand and supply plan of the business enterprise using the S&OP raw data; modeling a capacity constraint of the business enterprise using the S&OP raw data; modeling a new product introduction by the business enterprise using the S&OP raw data; and extrapolating at least one of a weekly, a multi-week, a monthly, a multi-month, a yearly, and a multi-year financial forecast of the business enterprise using the S&OP raw data.

The S&OP simulation may also involve balancing a demand criteria, a supply criteria, and a finance criteria of the business enterprise using the S&OP raw data. The S&OP simulation may further involve modeling a what-if scenario at a demand forecasting stage and a supply forecasting stage of the business enterprise using the S&OP raw data; and modeling a financial scenario at a demand forecasting stage and a supply forecasting stage of the business enterprise using the S&OP raw data.

The methods, devices, and systems disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and are not limited to the figures of the accompanying drawings, in which, like references indicate similar elements.

FIG. 1 illustrates a block diagram of a machine-implemented system of sales and operations planning, according to one or more embodiments.

FIG. 2A illustrates a plug-in interface of a machine-implemented system of sales and operations planning, according to one or more embodiments.

FIG. 2B illustrates a web-based spreadsheet interface of a machine-implemented system of sales and operations planning, according to one or more embodiments.

FIG. 3A illustrates a traditional database table for storing sales and operations planning raw data, according to one or more embodiments.

FIG. 3B illustrates a columnar database table for storing sales and operations planning raw data, according to one or more embodiments.

FIG. 4 illustrates a flowchart diagram of a process flow for an example business enterprise, according to one or more embodiments.

FIG. 5 illustrates a home page interface associated with a machine-implemented sales and operations planning system, according to one or more embodiments.

FIG. 6 illustrates an interface for searching and filtering planning items associated with a simulation performed by a machine-implemented sales and operations planning system, according to one or more embodiments.

FIG. 7 illustrates an interface for initiating a forecasting action of a machine-implemented sales and operations planning system, according to one or more embodiments.

FIG. 8A illustrates a demand and supply balancing dashboard associated with a machine-implemented sales and operations planning system, according to one or more embodiments.

FIG. 8B illustrates another view of a demand and supply balancing dashboard associated with a machine-implemented sales and operations planning system, according to one or more embodiments.

FIG. 9 illustrates a manufacturing capability dashboard associated with a machine-implemented sales and operations planning system, according to one or more embodiments.

FIG. 10 illustrates a demand planning dashboard associated with a machine-implemented sales and operations planning system, according to one or more embodiments.

FIG. 11 illustrates a scenario demand planning dashboard associated with a machine-implemented sales and operations planning system, according to one or more embodiments.

FIG. 12 illustrates a rough cut capacity planning (RCCP) dashboard associated with a machine-implemented sales and operations planning system, according to one or more embodiments.

FIG. 13 is a flowchart illustrating the machine-implemented method of sales and operations planning of a business enterprise, according to one or more embodiments.

FIG. 14 is a flowchart illustrating the machine-implemented method of sales and operations planning of a business enterprise, according to one or more embodiments.

Other features of the present embodiments will be apparent from the accompanying drawings and from the detailed description that follows.

### DETAILED DESCRIPTION

Disclosed are methods, devices, and systems providing sales and operations planning (S&OP) of a business enterprise. Although the present embodiments have been described with reference to specific example embodiments, it will be evident that various modifications and changes may be made to these embodiments without departing from the broader spirit and scope of the various embodiments. It should be understood by one of ordinary skill in the art that the terms “application(s),” “program(s),” “software,” “software code,” “sub-program(s),” “module(s),” and “block(s)” are industry terms that refer to computing instructions stored in a memory or storage device of a processing device and executable by a processor of the processing device.

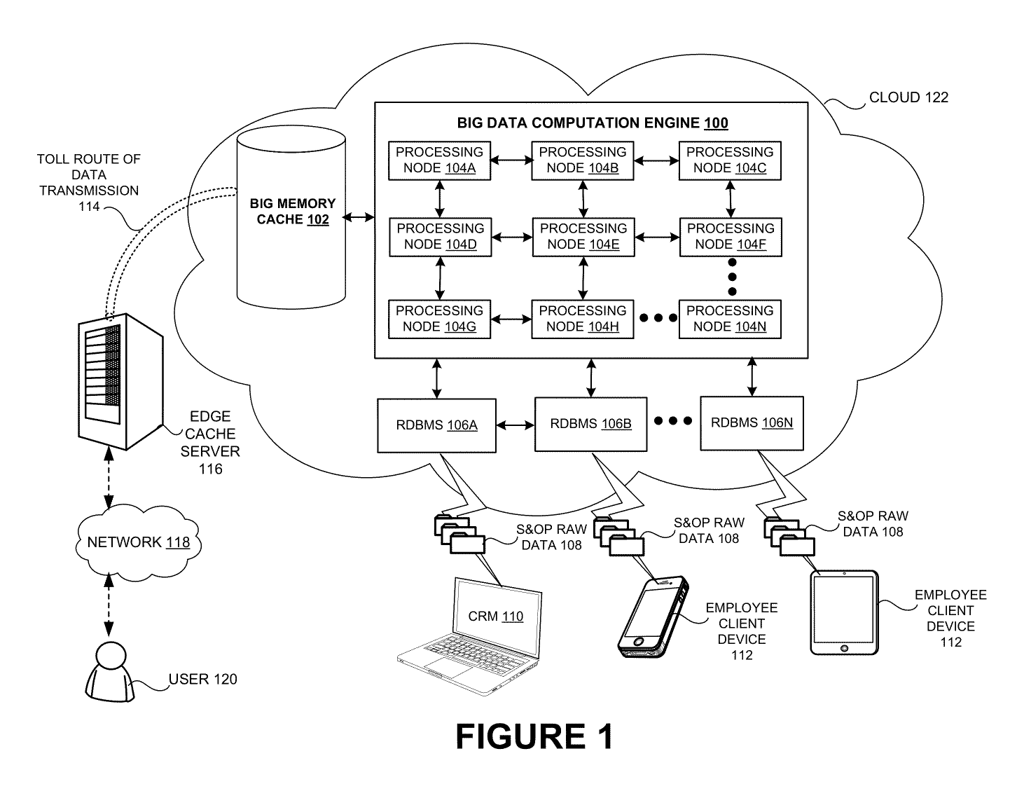

Reference is now made to FIG. 1, which illustrates a block diagram of a machine-implemented system of sales and operations planning. In one embodiment, the system may include a big data computation engine 100 configured to perform a sales and operations planning (S&OP) simulation. The big data computation engine 100 may include a number of processing nodes 104A-104N that are communicatively coupled to one another. The processing nodes 104A-104N may include one or more computing devices, for example a single server incorporating a processing unit or a cluster of servers incorporating processing units therein. In one embodiment, the processing nodes 104A-104N may include master and slave processing nodes. All the master processing nodes and slave processing nodes may reside on the same machine (e.g. a single-node installation) or they may be distributed amongst a cluster of machines. It should be understood by one of ordinary skill in the art that various types of servers and processing units may be used to carry out floating point calculations associated with the S&OP simulation. The processing nodes 104A-104N may also include a memory. In one embodiment, the memory associated with a processing node need not be substantial in size, and in some examples may be 8 GB or 16 GB. In one embodiment, the big data computation engine 100 may be located in a cloud computing environment, for example cloud 122. The cloud 122 may be accessed through a network 118 using protocols known by those skilled in the art. In one or more embodiments, the network 118 may be a Wide Area Network (WAN), a Local Area Network (LAN), etc. In some examples, the big data computation engine 100 may be implemented using a framework for the distributed processing of large data sets across clusters of computers, for example using the Apache Hadoop® software library. Additionally, a data warehouse system, for example Apache Hive®, may be implemented to facilitate easy data summarization, ad-hoc queries, and the analysis of large datasets.

In one embodiment, the big data computation engine 100 may be configured to collect an S&OP raw data 108. The big data computation engine 100 may be associated with one or more storage devices configured to store the S&OP raw data 108 in a database table. In some examples, the database table may be a columnar database table 300B, as will be described below. The S&OP raw data 108 may be used by the big data computation engine 100 to conduct the S&OP simulation. It may be advantageous to use the big data computation engine 100 instead of a local computing device for large data sets for a variety of reasons, such as to utilize the processing power and/or the memory of the big data computation engine 100. It may also be advantageous to use one big data computation engine 100 across a number of clients from different business enterprises to utilize an economy of scale. Processing nodes 104A-104N may be added to the big data computation engine 100 as needed.

The big data computation engine 100 may be communicatively coupled to a big memory cache 102. The big memory cache 102 may be configured to cache a result of the S&OP simulation. By caching the results of S&OP simulations and other requests from users, answers to queries may be delivered in a faster, more efficient manner. In one embodiment, the big memory cache 102 may be a computing device, for example a server, incorporating a storage unit, for example flash memory, therein. In one embodiment, the big memory cache 102 may be a storage device, for example a network-enabled hard drive. In some examples the big memory cache 102 may have a multi-terabyte capacity, for example 1-4 TB. It will be understood that various capacities may be used depending on the scale of calculations to be conducted. In one embodiment, the big memory cache 102 may be configured to store the S&OP raw data 108 in a database table. In some examples, the database table may be a columnar database table 300B. In one embodiment, the big memory cache 102 may be located in the cloud 122. In some examples, the big memory cache 102 may use a data management system, for example Terracotta BigMemory®, to implement a distributed memory system across multiple servers with minimal performance hits. In one embodiment, the big data computation engine 100 and/or the big memory cache 102 may use a fault-tolerant file system, for example the Hadoop Distributed File System (HDFS).

The big data computation engine 100 may also be communicatively coupled to one or more relational database management systems (RDBMS) 106A-106N. The RDBMS 106A-106N may be configured to collect and/or aggregate the S&OP raw data 108. The RDBMS 106A-106N may be configured to obtain the S&OP raw data 108 from a client device, for example a customer relationship management program 110 or an employee client device 112. The RDBMS 106A-106N may be configured to forward the S&OP raw data 108 to the big data computation engine 100. In one embodiment, the RDBMS 106A-106N may be configured to store the S&OP raw data 108 in a database table. In some examples, the database table may be a columnar database table 300B. In one embodiment, the RDBMS may be located in the cloud 122. In one embodiment, the RDBMS 106A-106N may be implemented using MySQL or Oracle.

The big memory cache 102 may be communicatively coupled to an edge cache server 116. In one embodiment, a number of edge cache servers 116 may be located at different geographical points. The edge cache server 116 may be configured to edge cache the result of the S&OP simulation near a geographical point of origin of the client device. In one embodiment, the edge caching of the result of the S&OP simulation may be accelerated by a toll route of data transmission 114. The toll route of data transmission 114 may be implemented by any known network traffic management technique, such as traffic shaping, quality of services (QoS) policies, a differentiated services architecture, or an integrated services architecture. In one embodiment, data packets associated may be given priority based on a fee paid to an Internet service provider. It will be understood that other mechanisms for prioritizing packet delivery may be used to implement the toll route of data transmission 114. The edge cache server 116 may be configured to communicate the result of the S&OP simulation to a user 120 through the network 118. Caching results in geographical proximity to the origin of a query may reduce latency in delivering the result to the user 120. In one embodiment, the result of the S&OP simulation cached in the edge cache server 116 may be displayed through a plug-in interface of an off-the-shelf spreadsheet program, as will be described below. In another embodiment, the result of the S&OP simulation cached in the edge cache server 116 may be displayed through a web-based spreadsheet program, as will be described below.

The edge cache server 116 and/or the big data computation engine 100 may be configured to respond to the user 120 or users based on a profile of the user 120 or users. For example, a sales account executive of the business enterprise would be provided with a response for sale related queries such as projected target sales, items sold, etc. In another example, a vice president of sales of the business enterprise would be provided with a response for the queries on plans, projected sales, target sales and the like. Each of the user(s) 120 may be provided with a profile and the edge cache server 116 and/or the big data computation engine 100 may be configured to respond to each of the user(s) 120 based on the user profile. Each of the user(s) 120, based on the profile, may be provided with options such as access to files, type of user interfaces and other report-generating options. It will be understood that a different computing device may be implemented to interact with the user(s) 120.

The S&OP raw data 108 may be a historical or forward-looking data input from an enterprise resource planning (ERP) program, a customer relationship management (CRM) program 110, a supplier relationship management (SRM) program, a material resource planning (MRP) program, a stock-keeping unit (SKU) database, and/or a user client device 112 (also referred to as an employee client device). For example, the S&OP raw data 108 may be obtained from SAP, Salesforce.com, and/or Big Machines, and then normalized. In one embodiment, the S&OP raw data 108 may be real-time data. In one embodiment, data from ERP, CRM, SRM, MRP, and/or SKU systems may be aggregated into a single, unified platform for strategic business planning. In one embodiment, the S&OP raw data 108 may be imported to any of the big data computation engine 100, the big memory cache 102, and the RDBMS 106A-106N through an interface of an S&OP application installed on the user client device 112. In one embodiment, the S&OP raw data 108 may be imported from the RDBMS 106A-106N to a data warehouse system, for example Apache Hive®, of the big data computation engine 100 by using commonly available tools known by those skilled in the art, for example Apache Sqoop™. In one embodiment, the S&OP raw data 108 may be exported from the big data computation engine 100 back to the RDBMS 106A-106N by using commonly available tools known by those skilled in the art, for example Hadoop MapReduce.

The S&OP simulation may be performed by one or more processing nodes 104A-104N of the big data computation engine 100 using the S&OP raw data 108. The S&OP simulation may include modeling a historical or forward-looking profitability of the business enterprise using the S&OP raw data 108. The S&OP simulation may further include modeling a demand and supply plan of the business enterprise using the S&OP raw data 108. The S&OP simulation may additionally include modeling a capacity constraint of the business enterprise using the S&OP raw data 108. The S&OP simulation may include modeling a new product introduction by the business enterprise using the S&OP raw data 108. The S&OP simulation may also include extrapolating at least one of a weekly, a multi-week, a monthly, a multi-month, a yearly, and a multi-year financial forecast of the business enterprise using the S&OP raw data 108.

The S&OP simulation may also include balancing a demand criteria, a supply criteria, and a finance criteria of the business enterprise using the S&OP raw data 108. The S&OP simulation may additionally include modeling a what-if scenario at a demand forecasting stage and a supply forecasting stage of the business enterprise using the S&OP raw data 108. The S&OP simulation may also include modeling a financial scenario at a demand forecasting stage and a supply forecasting stage of the business enterprise using the S&OP raw data 108. The modeling may include taking into account the import and export controls that are a characteristic of the business enterprise.

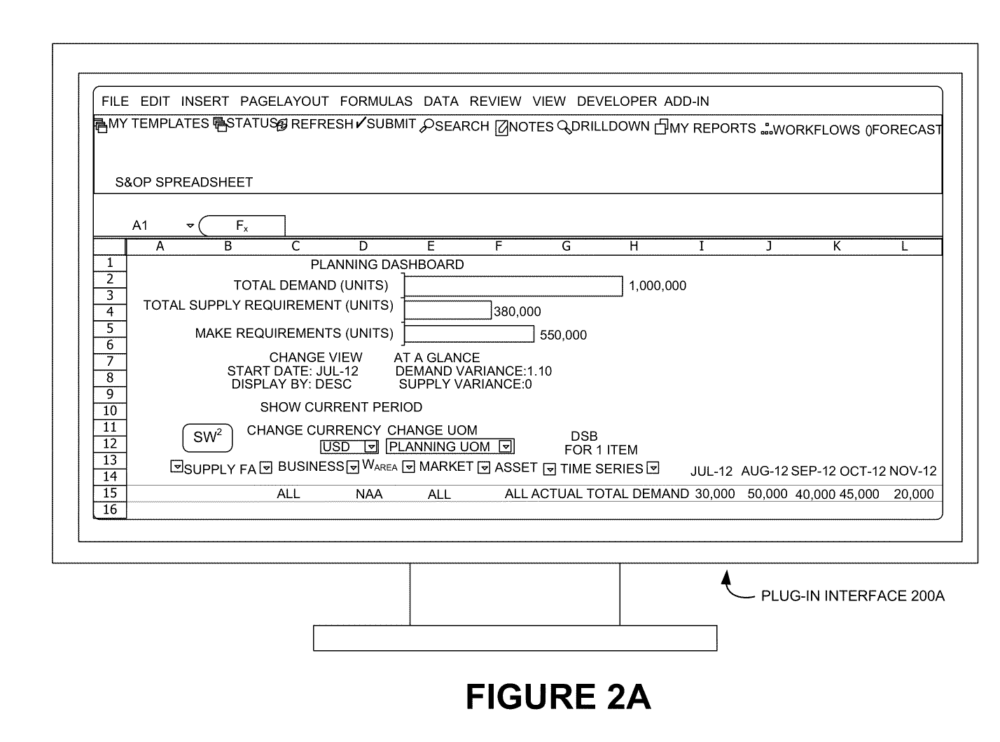

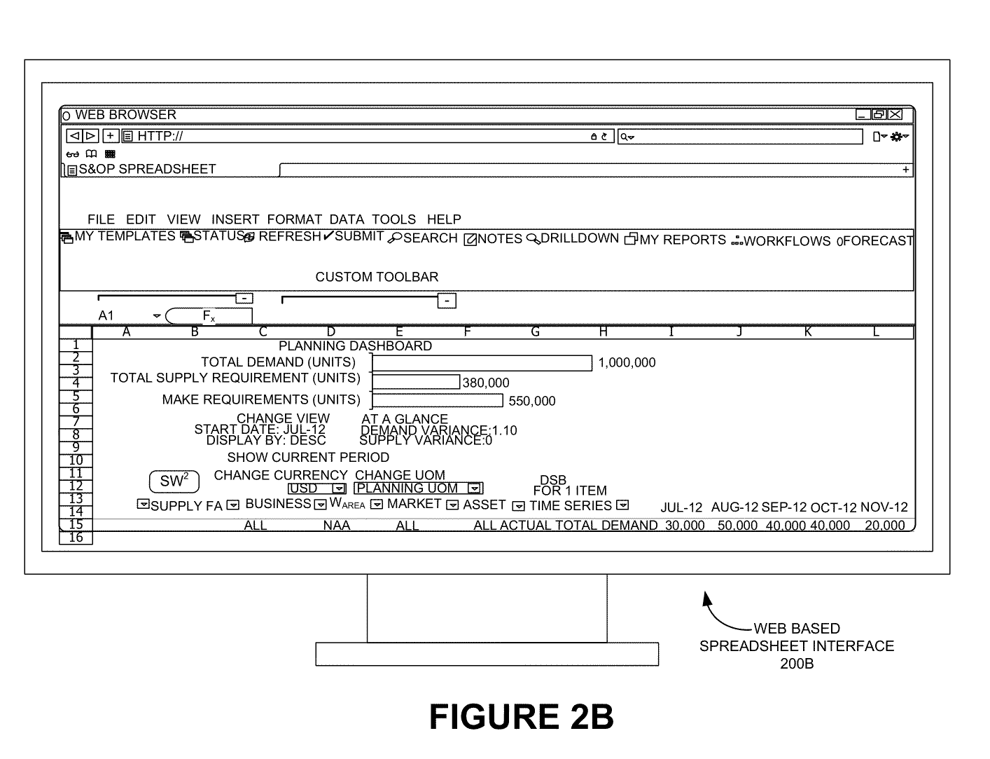

Reference is now made to FIG. 2A, which illustrates a plug-in interface 200A of a machine-implemented system of sales and operations planning. The plug-in interface 200A may be implemented for use with a conventional, off-the-shelf spreadsheet application, for example Microsoft Excel. The spreadsheet application may be used to display the result of the S&OP simulation in a user-readable interface as will be described below. In one embodiment, the big data computation engine 100 may perform the S&OP simulation, and send the result to the plug-in interface 200A for review by the user 120. In some examples, the spreadsheet application may perform some calculations associated with the S&OP simulation.

Reference is now made to FIG. 2B, which illustrates a web-based spreadsheet interface 200B of a machine-implemented system of sales and operations planning, according to one or more embodiments. The web-based spreadsheet interface 200B may be displayed to a user 120 via a web browser. The web-based spreadsheet interface 200B may be implemented by programming languages known in the art, for example HTML, Javascript, or Ruby on Rails. In some examples, the web-based spreadsheet interface 200B may be implemented to appear similar in look and feel relative to the plug-in interface 200A.

In one or more embodiments, the plug-in interface 200A or the web-based spreadsheet interface 200B may be any of, but not limited to management interface, search entry navigation interface, etc. In one or more embodiments, the plug-in interface 200A or the web-based spreadsheet interface 200B may be configured to display S&OP parameters, for example S&OP raw data 108, S&OP simulation parameters, S&OP planning data, or S&OP templates. In one or more embodiments, based on the S&OP parameters, the big data computation engine 100 may be configured to conduct the S&OP simulation. After each S&OP simulation is conducted, the plug-in interface 200A or the web-based spreadsheet interface 200B may be configured to only update the elements that change as compared to the previous time the S&OP simulation was run.

In one or more embodiments, the plug-in interface 200A or the web-based spreadsheet interface 200B may also include an administrative user interface designed to carry out various functions. In one or more embodiments, the functions may include, but are not limited to, sending notification e-mails, creating a backup of assignments and sending the assignments, assigning the access to a portion of the application of sales and operations planning, etc. In one or more embodiments, the plug-in interface 200A or the web-based spreadsheet interface 200B may include options for the user 120 to receive an email alert and/or a Short Message Service (SMS) based on timing or event criteria defined by the user 120.

In one or more embodiments, the plug-in interface 200A or the web-based spreadsheet interface 200B may include a template manager and worksheet generators which may be combination frameworks. In one or more embodiments, templates may be the views which are used to view the data within worksheet/spreadsheet. In one or more embodiments, the spreadsheets/worksheets may be the instances of the templates. In one or more embodiments, the user(s) 120 may manage the views, the order of time series that appear in the templates, etc.

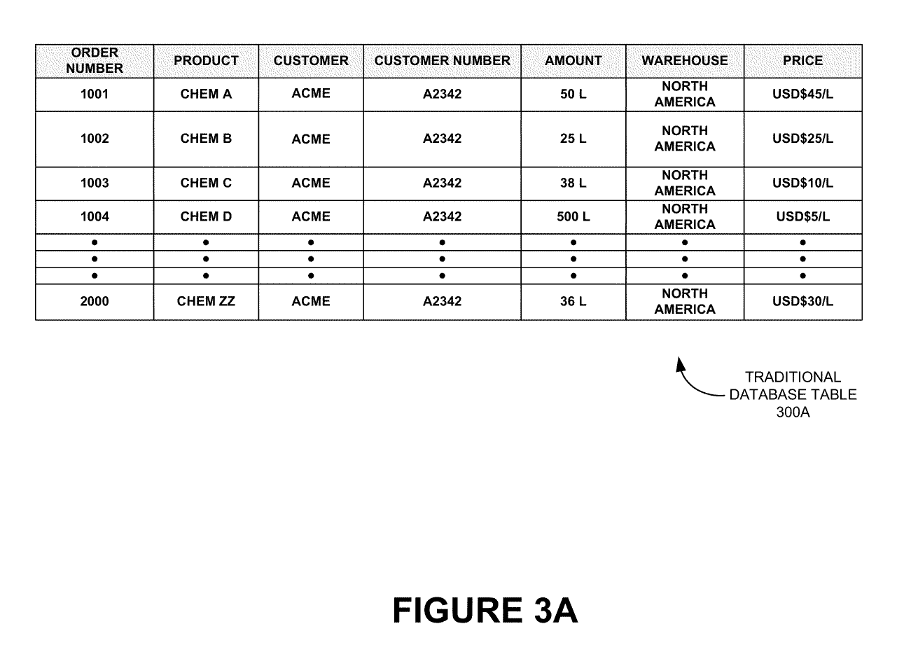

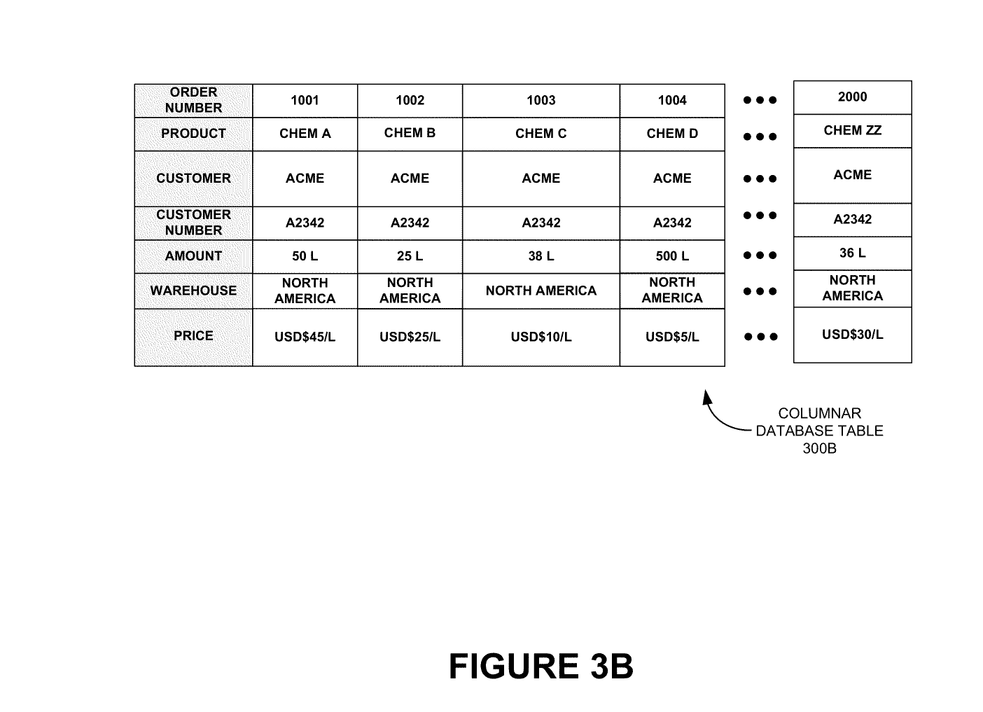

Reference is now made to FIG. 3A, which illustrates a traditional database table 300A for storing sales and operations planning raw data, according to one or more embodiments. In one embodiment, the traditional database table 300A may include entries relevant to the business enterprise, such as order number, product, customer, customer number, amount, warehouse and/or price. A database table for storing sales and operations planning raw data may contain billions of entries. In one embodiment, the data in the traditional database table 300A may be normalized. Additionally, data may be stored in a record by record label structure.

Reference is now made to FIG. 3B, which illustrates a columnar database table 300B for storing sales and operations planning raw data, according to one or more embodiments. In one embodiment, the columnar database table 300B may include entries relevant to the business enterprise, such as order number, product, customer, customer number, amount, warehouse and/or price. A columnar database table 300B may be a transpose of the traditional database table 300A. A columnar database table 300B may offer performance improvements for S&OP calculations because columnar technology is faster in querying the same item across many rows of data. Further, a column-oriented layout may permit columns that are not accessed in a query to be skipped. Additionally, a columnar database table 300B may offer reduced storage requirements because columnar databases rarely use user-defined indexes. In one embodiment, the columnar database table 300B may be implemented in a data warehouse system, for example Apache Hive®.

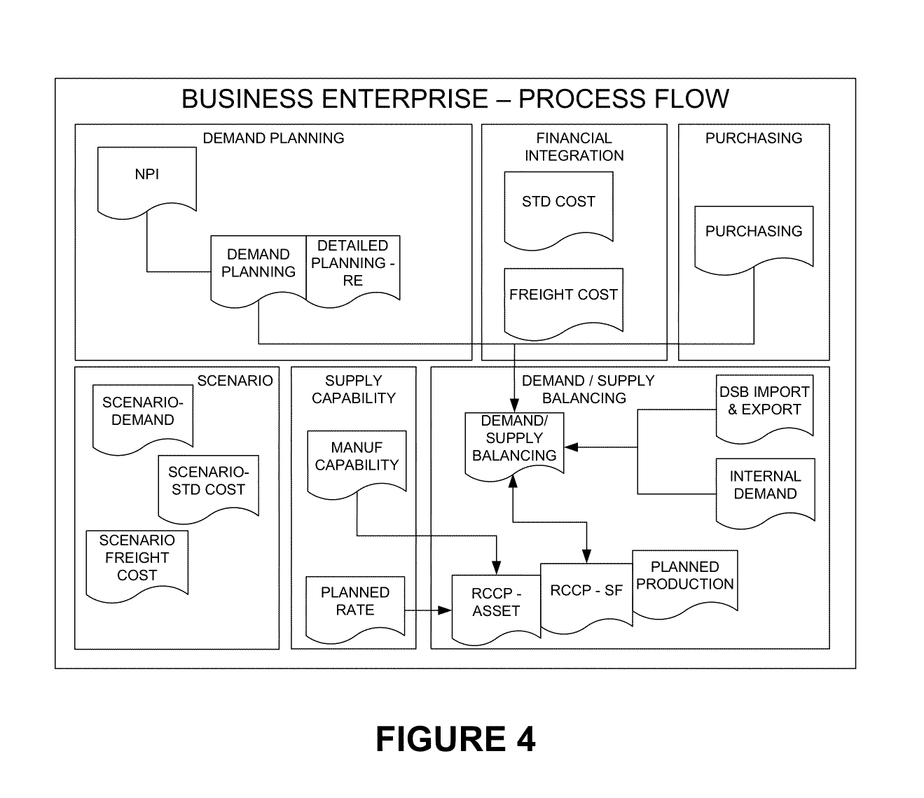

Reference is now made to FIG. 4, which illustrates a flowchart diagram of a process flow for an example business enterprise. In one embodiment, the process flow for a business enterprise may include demand planning, financial integration, purchasing analysis, scenario analysis, supply capability analysis, and demand/supply balancing. The S&OP simulation may be implemented in light of the process flow for the business enterprise. For example, demand criteria and supply criteria may be specific to a particular business enterprise, thereby necessitating a specialized business process flow involving specialized calculations. Thus, there is a need for a system customizable to perform large-scale computations based on specialized business process flows.

Demand planning may be initiated in preparation of a new product introduction (NPI). The demand plan may be based on one or more predefined factors. Examples of the predefined factors may include, but are not limited to, sales, finance, product marketing and strategic management. For example, the demand plan may be created in the cloud 122 based on a demand forecasting algorithm that considers multi-party input in client-side visualizations of a certain aspect of the demand plan appropriate to a demand-side stakeholder based on a rules-based algorithm that considers a demand-side access privilege and a demand-side role of the demand-side stakeholder. A certain aspect may be a segmented view of the demand plan depending on a role and/or responsibility of a stakeholder to the enterprise. The factors and aspects may be aggregated to obtain a demand criteria to be used in demand/supply balancing. The S&OP raw data 108 may include the demand criteria, and the big data computation engine 100 may perform the S&OP simulation using the S&OP raw data 108 with the demand criteria incorporated therein.

In a business enterprise, there may be demand criteria due to the nature of the industry. An internal demand may be a demand within, for example within a business unit of, the business enterprise. In some examples, there may be international demands when the business enterprise is located in multiple countries. The international demands may be categorized as import and export demands. The number of types of demands may be aggregated to produce a total demand to be used for demand/supply balancing.

A supply plan may be based on one or more predefined factors. Examples of the predefined factors may include, but are not limited to, raw material providers and logistics. For example, the supply plan may be created in the cloud 122 based on a supply-forecasting algorithm that considers multi-party input in client-side visualizations of a particular aspect of the supply plan appropriate to a supply-side stakeholder based on a rules-based algorithm that considers a supply-side access privilege and a supply-side role of the supply-side stakeholder. A particular aspect may be a segmented view of the supply plan depending on a role and/or responsibility of a stakeholder to the business enterprise.

The total supply may be balanced with the total demand to calculate a make requirement. In one embodiment, supply families may be prioritized in a multi-level balancing implementation. A dependent demand may be created when a supply unit cannot meet the make requirement. In one embodiment, the demand and supply may be balanced to produce a safety stock. In one embodiment, the demand/supply balancing may be performed using finance criteria such as standard costs and freight costs. In one embodiment, the demand/supply balancing may be performed using purchasing metrics.

There may also be a supply criteria that may be balanced with the demand criteria. The supply criteria may include a supply capability analysis, which may involve analyzing capacity constraints, the manufacturability and the planned rate. Additionally, the supply may include a number of supply families. The supply families may be separate business units capable of producing an asset. The supply criteria may be aggregated to produce a total supply requirement. The S&OP raw data 108 may include the supply criteria, and the big data computation engine 100 may perform the S&OP simulation using the S&OP raw data 108 with the supply criteria incorporated therein.

In one embodiment, the demand/supply balancing may include a resource leveling analysis to examine unbalanced use of resources over time. It may be advantageous to perform resource leveling to resolve over-allocations or conflicts. A rough cut capacity planning (RCCP) profile may be used in resource leveling to plan the requirements of one or more resources. The resources may include, but are not limited to, work center capabilities, materials, production resources/tools, and costs. The resource leveling analysis may involve performing a S&OP simulation by the big data computation engine 100 using S&OP raw data 108 incorporating resource leveling factors therein. The resource leveling factors may be data related to the one or more resources and their requirements.

Scenario planning may include short term or long term demand/supply planning. A scenario may be a production-safe sandbox where different operational and financial options can be exercised and discussed. Scenario planning may include a demand analysis, which may involve determining effects of adjustments in price on margins. Scenario planning may further include a standard cost analysis, which may involve determining effects of adjustments in standard costs on margins. Scenario planning may additionally include a freight cost analysis, which may involve determining effects of changes in freight costs on margins. In some examples, scenarios may be saved in local memory, the big memory cache 102, or another storage device for future reference. In one example, a user may create a scenario involving changing costs, revenue and/or price to see the effect on the plan. In one embodiment, the results of multiple scenarios may be displayed simultaneously in a single graphical representation. Scenario planning may involve performing an S&OP simulation using the big data computational engine 100, wherein the S&OP raw data 108 used to perform the S&OP simulation incorporates factors relevant to the scenario.

In one embodiment, different stages of S&OP may be conducted in a month. In the first week of the month, a sales & marketing team associated with a business enterprise may forecast data. In the second and third week of the month, demand planning may be conducted. In the fourth week of the month, demand/supply balancing may be conducted.

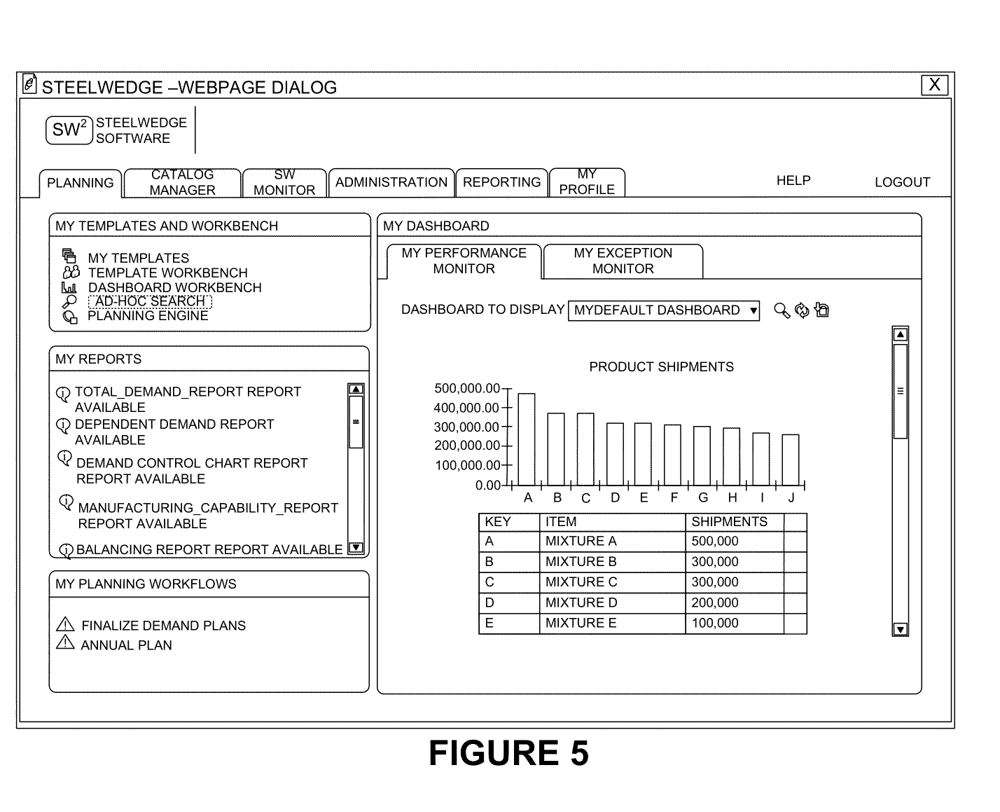

Reference is now made to FIG. 5, which illustrates a home page interface associated with a machine-implemented sales and operations planning system. The home page interface may include a number of tabs, such as planning, catalog manager, monitor, administration, reporting and profile tabs. The planning tab may include an interface displaying links to templates, reports, and workflows. Planning templates may be accessed, created, or managed through the planning tab interface. In some examples, a first user may assign a planning template to a second user. User(s) 120 may also access reports through the planning tab interface. In addition, user(s) 120 may be alerted to needed actions through workflow alerts displayed in the planning tab interface. Additionally, a portion of the planning tab interface may be used to display graphical representations of different personalized dashboards relating to exceptions and performance planning, for example a demand and supply balancing dashboard. The personalized dashboards may be graphical representations of the results of various types of S&OP simulations performed by the big data computation engine 100. In some examples, a first user may assign a dashboard to a second user. In one embodiment, an ad-hoc search link may direct a user to an interface in which user(s) 120 may select planning items, associate them with a template, and download them.

In one or more embodiments, the catalog manager tab may include an interface in which the user(s) 120 can manage data within the application. In one or more embodiments, the catalog manager may assist in mapping the data. The monitor tab may include an interface in which user(s) 120 can monitor job queues to check on the processing of overrides. The catalog manager may include an interface in which a user can search and edit planning items, create and maintain filters, create temporary items and product/market relationships, and perform mass updates. The administration tab may include an interface in which user(s) 120 can perform administrative tasks. The profile tab may include an interface in which user(s) can adjust personal settings, for example passwords.

Additionally, the reporting tab may include an interface to allow a user 120 to view, copy, and/or edit various kinds of reports, for example market reports, sales reports, or standard reports. In one embodiment, the reporting interface may allow a user to access a multi-panel report. The multi-panel report may include retail data, wholesale data, production data, stock data, and/or measure data. The data may be actual data or forecast data. The reports may include public, private, and administrative reports. The data for the multi-panel report may be obtained by performing an S&OP simulation using the big data computation engine 100.

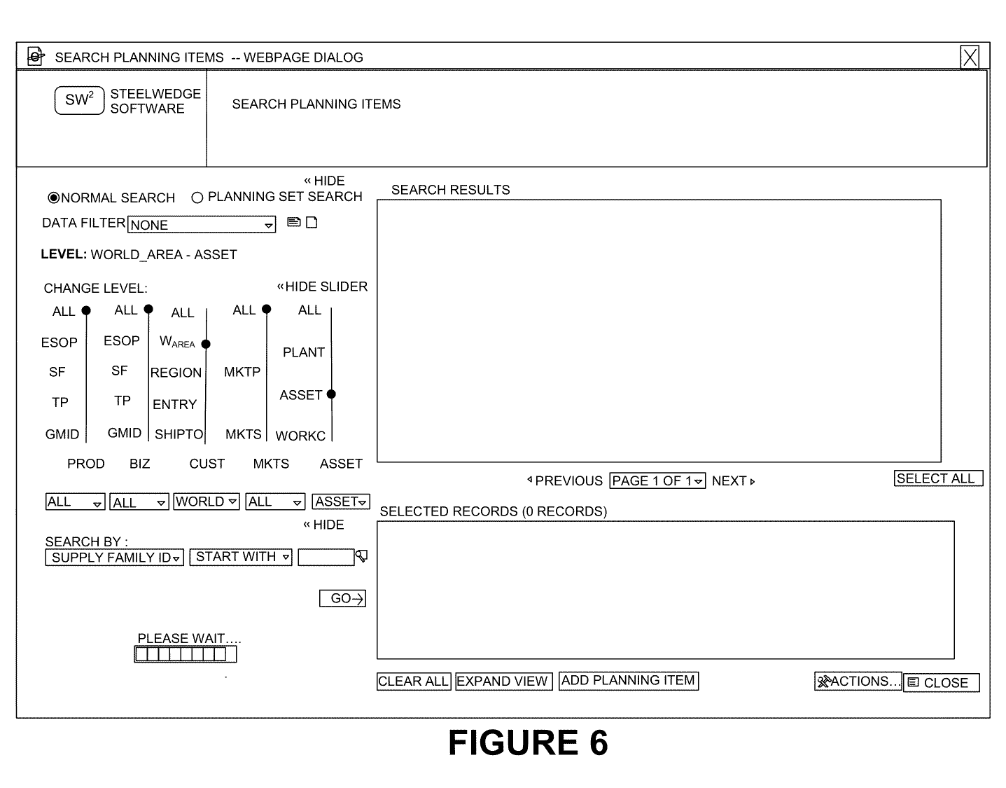

Reference is now made to FIG. 6, which illustrates an interface for searching planning items associated with a machine-implemented sales and operations planning system. The search planning items interface may be configured to present options to a user 120 based on the user's 120 access level. For example, a user 120 in a certain geographical market may only be presented options related to that geographical market. The search planning items interface may be configured to allow the user 120 to access various kinds of data associated with sales and operations planning, for example forecast data or actuals data. The search planning items interface may include one or more level selection interfaces, for example sliders. In some examples, the level selection interfaces may represent hierarchies of data. Additionally, the search planning items interface may include a data filter interface in which the user 120 may search for a particular type of data. In some examples, the user 120 may be presented with an interface to search data sets by additional criteria or attributes. After specifying a search criteria, the user 120 may be presented with search results containing records that may be chosen for display by the user 120. The search planning items interface may communicate with the edge cache server 116, the big memory cache 102, and/or the big data computation engine 100 to search for planning items.

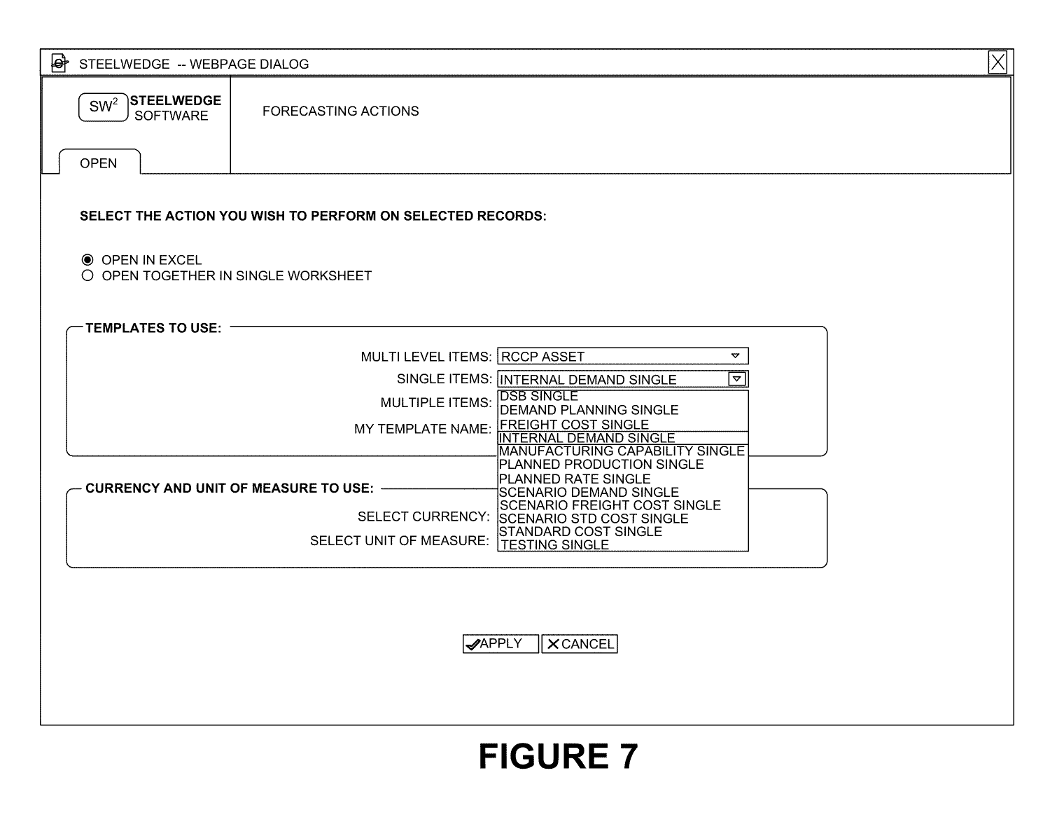

Reference is now made to FIG. 7, which illustrates an interface for initiating a forecasting action of a machine-implemented sales and operations planning system. A forecasting action may be a type of S&OP simulation that may be performed by the big data computation engine 100. The forecasting action may be performed to achieve a simulation objective such as reducing cost or reducing time. A number of simulation objectives may be chosen, as will be appreciated by one skilled in the art. The forecasting action may be performed using templates chosen by the user 120. The forecasting action interface may provide options for the user 120 to present the result of the forecasting action in a spreadsheet program, for example Microsoft Excel, and/or present the result of the forecasting action in a single worksheet.

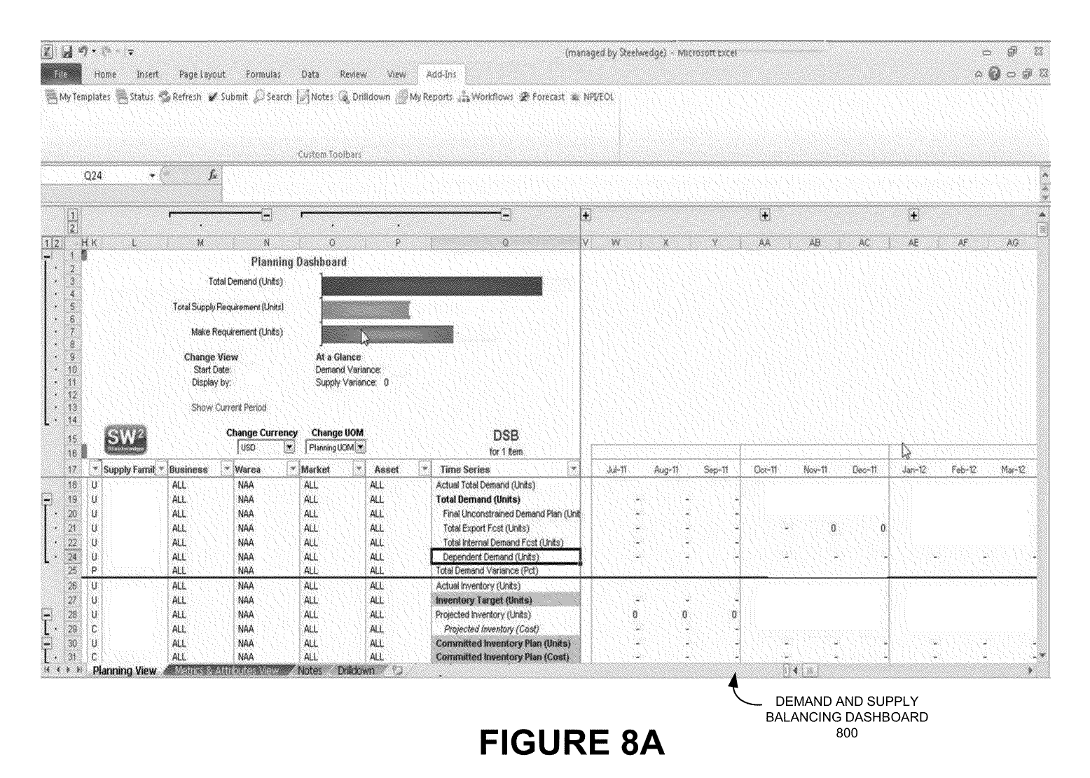

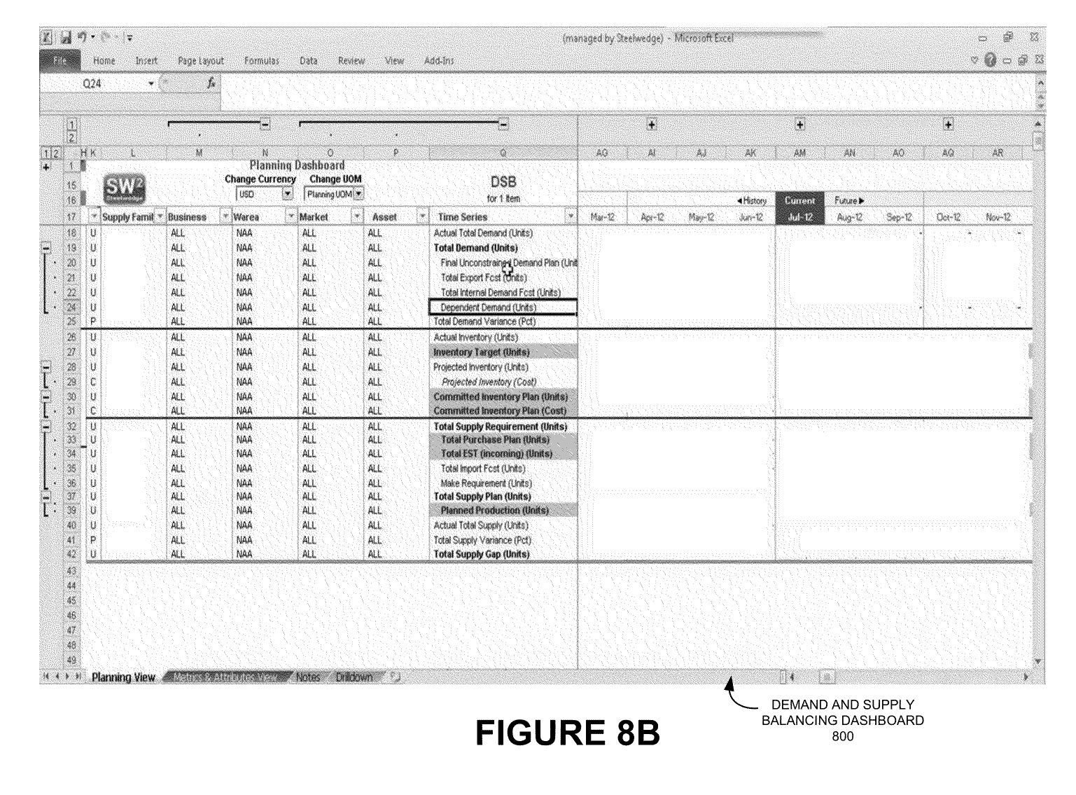

Reference is now made to FIGS. 8A and 8B, which illustrate a demand and supply balancing dashboard 800 associated with a machine-implemented sales and operations planning system. The demand and supply balancing dashboard 800 may include a planning dashboard providing a graphical representation of any of the S&OP raw data 108 and the S&OP simulation results. The demand and supply balancing dashboard 800 may provide a user-readable representation of the S&OP raw data 108 and/or the S&OP simulation results. In one embodiment, the demand and supply balancing dashboard 800 may display data relating to the demand planning portion and/or the demand/supply balancing portion of the process flow shown in FIG. 4. The demand and supply balancing dashboard 800 may be communicatively coupled to a database associated with the RDBMS 106A-106N, the big data computation engine 100 or the big memory cache 102. The demand and supply balancing dashboard 800 may include supply family data, business data, area data, market data, asset data, and time series data. The time series data may include parameters such as total demand, total supply requirement, total supply plan and total supply gap. Data in the demand and supply balancing dashboard 800 may be modified by a user, for example an account manager, to send a result back to the database associated with the RDBMS 106A-106N, the big data computation engine 100 and/or the big memory cache 102.

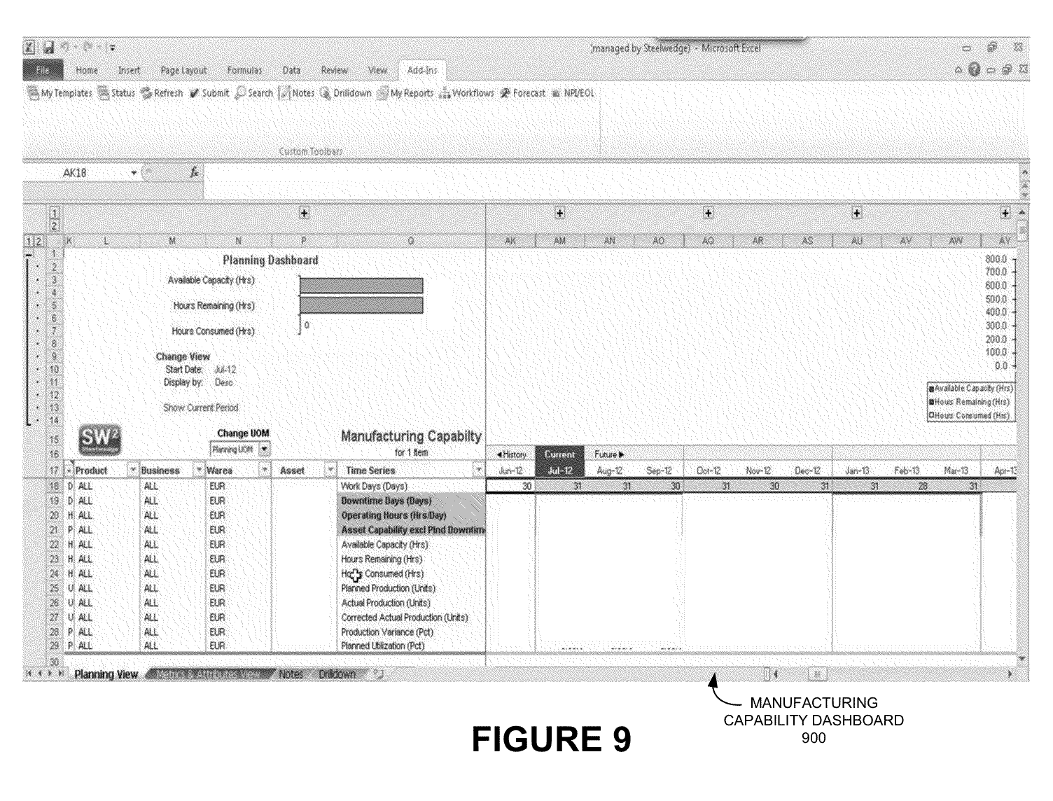

Reference is now made to FIG. 9, which illustrates a manufacturing capability dashboard 900 associated with a machine-implemented sales and operations planning system. The manufacturing capability dashboard 900 may include a planning dashboard providing a graphical representation of the S&OP raw data 108 and/or the S&OP simulation results. The manufacturing capability dashboard 900 may provide a user-readable representation of any of the S&OP raw data 108 and the S&OP simulation results. In one embodiment, the manufacturing capability dashboard 900 may display data relating to the supply capability portion of the process flow shown in FIG. 4. The manufacturing capability dashboard 900 may be communicatively coupled to a database associated with the RDBMS 106A-106N, the big data computation engine 100 or the big memory cache 102. The manufacturing capability dashboard 900 may include product data, business data, area data, market data, asset data, and time series data. The time series data may include parameters such as work days, downtime days, operating hours, asset capability and available capacity. Data in the manufacturing capability dashboard 900 may be modified by a user, for example an account manager, to send a result back to the database associated with the RDBMS 106A-106N, the big data computation engine 100 or the big memory cache 102.

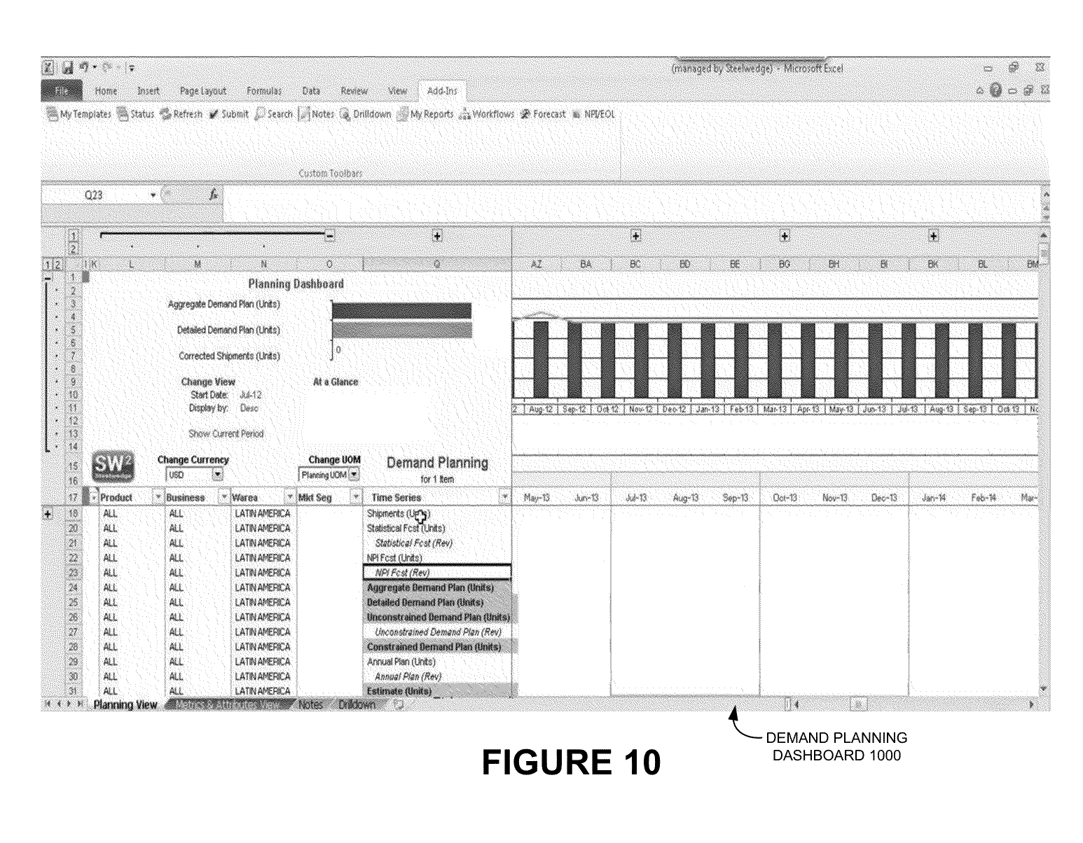

Reference is now made to FIG. 10, which illustrates a demand planning dashboard 1000 associated with a machine-implemented sales and operations planning system. The demand planning dashboard 1000 may provide a user-readable representation of the S&OP raw data 108 and/or the S&OP simulation results. In one embodiment, the demand planning dashboard 1000 may display data relating to the demand planning portion of the process flow shown in FIG. 4. The demand planning dashboard 1000 may be communicatively coupled to a database associated with the RDBMS 106A-106N, the big data computation engine 100 or the big memory cache 102. The demand planning dashboard 1000 may include family data, customer data, source data and time series data. The time series data may include parameters such as aggregate demand plan, detailed demand plan, unconstrained demand plan, and constrained demand plan. The demand planning dashboard 1000 may also include a planning dashboard that may display a graphical representation of an aggregate demand plan, a detailed demand plan and a corrected shipments metric. The demand planning dashboard 1000 may also include a graphical representation of the time series data. Data in the demand planning dashboard 1000 may be modified by a user 120, for example an account manager, to send a result back to the database associated with the RDBMS 106A-106N, the big data computation engine 100 or the big memory cache 102. In one embodiment, an interface may be provided for the user 120 to indicate a reason for making the modifications. Reasons may include, but are not limited to, management adjustment, customer demand, price adjustment, and error correction.

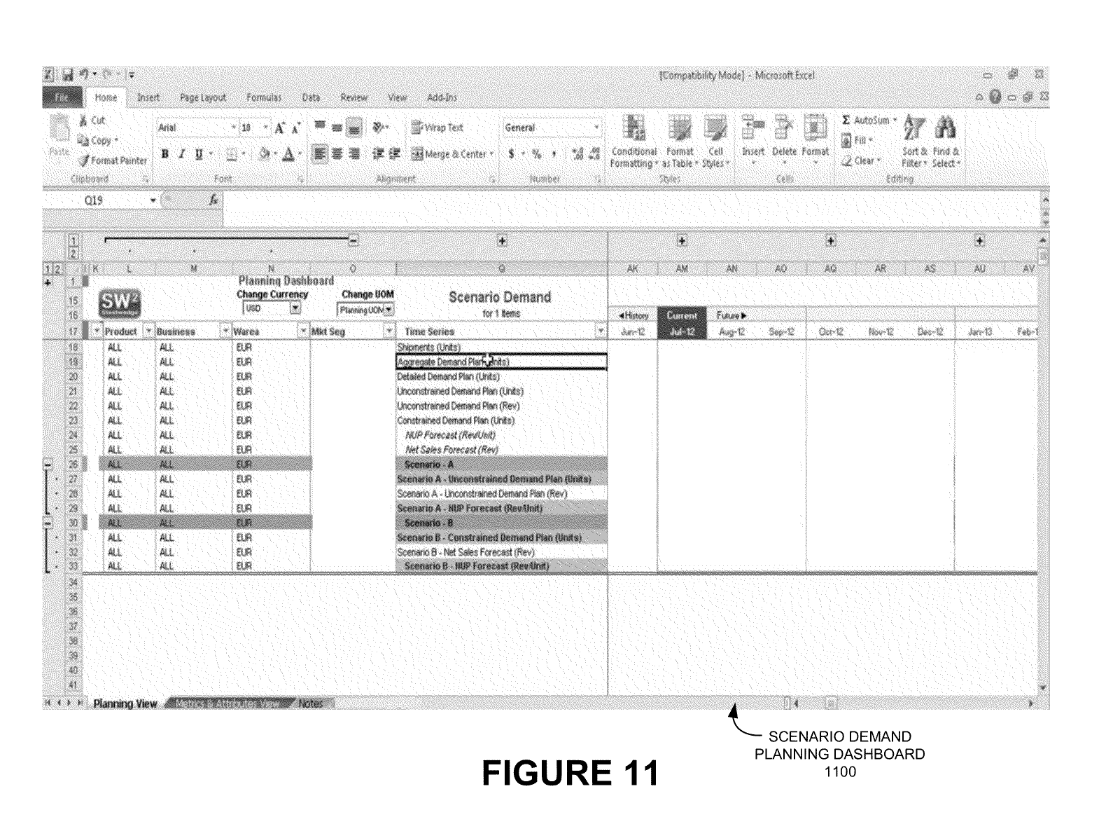

Reference is now made to FIG. 11, which illustrates a scenario demand planning dashboard 1100 associated with a machine-implemented sales and operations planning system. The scenario demand planning dashboard 1100 may provide a user-readable representation of the S&OP raw data 108 and/or the S&OP simulation results. In one embodiment, the scenario demand planning dashboard 1100 may display data relating to the scenario portion of the process flow shown in FIG. 4. The scenario demand planning dashboard 1100 may be communicatively coupled to a database associated with the RDBMS 106A-106N, the big data computation engine 100 or the big memory cache 102. The scenario demand planning dashboard 1100 may include product data, business data, area data, market segment data, and time series data. The time series data may include parameters such as aggregate demand plan, detailed demand plan, unconstrained demand plan for at least one specific scenario, and constrained demand plan for at least one specific scenario. Data in the scenario demand planning dashboard 1100 may be modified by a user 120, for example an account manager, to send a result back to the database associated with the RDBMS 106A-106N, the big data computation engine 100 or the big memory cache 102.

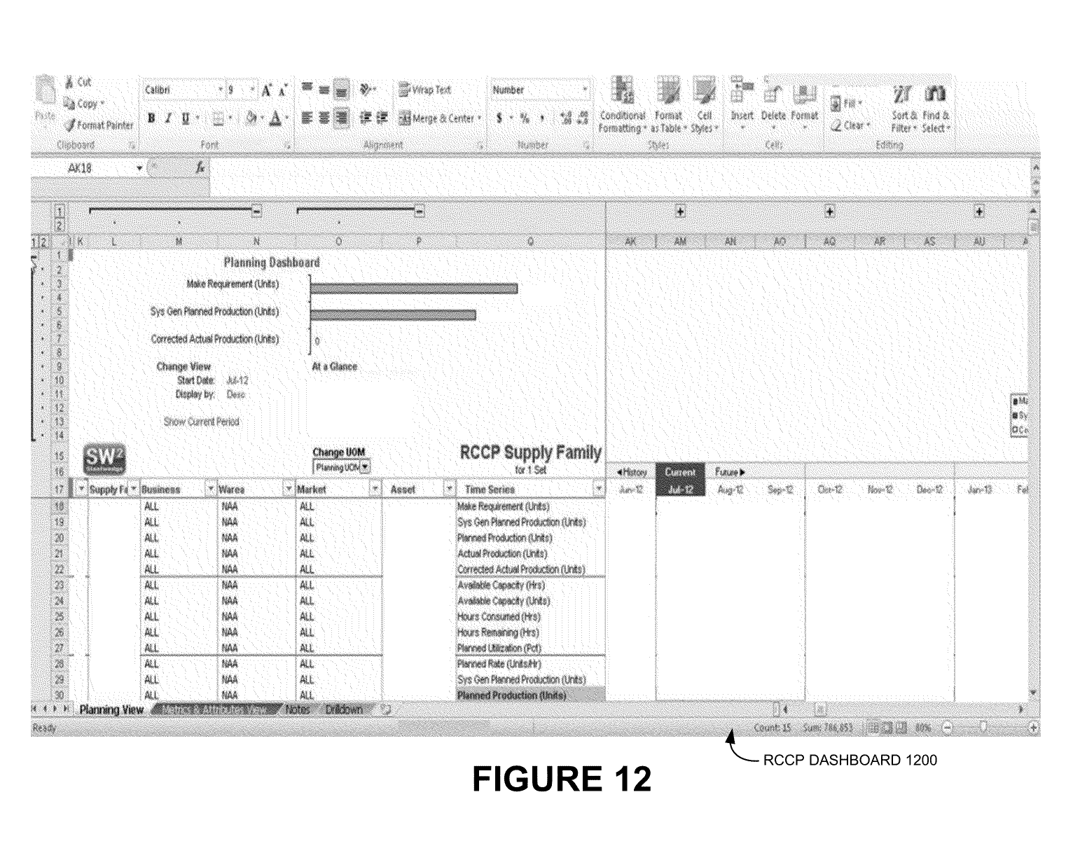

Reference is now made to FIG. 12, which illustrates a RCCP dashboard 1200 associated with a machine-implemented sales and operations planning system. The RCCP dashboard 1200 may provide information related to capacity limits. The RCCP dashboard 1200 may provide a user-readable representation of the S&OP raw data 108 and/or the S&OP simulation results. In one embodiment, the RCCP dashboard 1200 may display data relating to the demand demand/supply balancing portion of the process flow shown in FIG. 4. The RCCP dashboard 1200 may be communicatively coupled to a database associated with the RDBMS 106A-106N, the big data computation engine 100 or the big memory cache 102. The RCCP dashboard 1200 may include family, data, customer data, source data and time series data. The RCCP dashboard 1200 may also include a planning dashboard that may display a graphical representation of an unconstrained build plan, a capacity limit, and a production plan. The RCCP dashboard 1200 may also include a graphical representation of the time series data. Data in the demand planning dashboard 1200 may be modified by a user 120, for example an account manager, to send a result back to the database associated with the RDBMS 106A-106N, the big data computation engine 100 or the big memory cache 102. In one example, the RCCP dashboard 1200 may be modified to take corrective action in view of a capacity constraint by increasing the production plan prior to the capacity constraint.

In one embodiment, the demand and supply balancing dashboard 800, the manufacturing capability dashboard 900, the demand planning dashboard 1000, the scenario demand planning dashboard 1100, and/or the RCCP dashboard 1200 may include a toolbar providing the user 120 with quick access to sales and operations planning functions. The tool bar may provide a link for the user to submit a modification, for example an override. An override may allow the user 120 to modify a forecast value and/or time series data. The user 120 may be provided with an interface to submit a reason code and/or notes to provide more information on changes made to the data. Additionally, the tool bar may provide a drilldown function that the user 120 may select to obtain more detail and/or audit trails in relation to data entries. In some examples, the user 120 may use the drilldown functionality to perform inquiries into abnormalities in data entries.

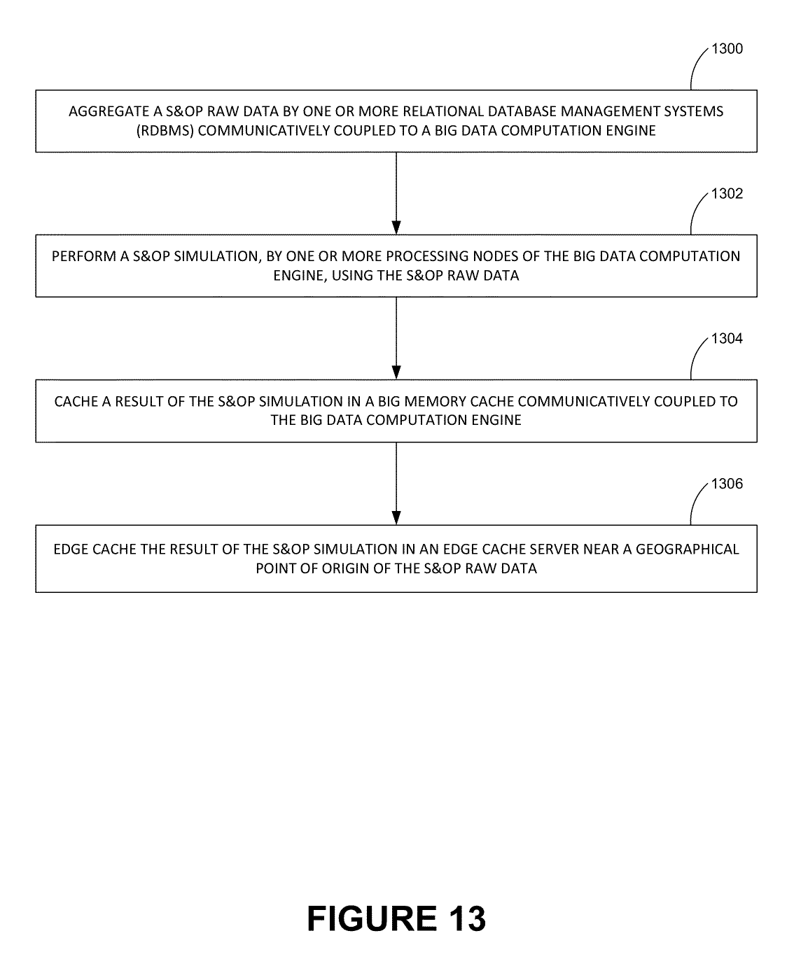

Reference is now made to FIG. 13, which is a flowchart illustrating the machine-implemented method of sales and operations planning of a business enterprise, according to one or more embodiments. Operation 1300 involves aggregating a S&OP raw data 108 by one or more relational database management systems (RDBMS) 106A-106N communicatively coupled to a big data computation engine 100. Operation 1302 involves performing a S&OP simulation, by one or more processing nodes of the big data computation engine 100, using the S&OP raw data 108. Operation 1304 involves caching a result of the S&OP simulation in a big memory cache 102 communicatively coupled to the big data computation engine 100. Operation 1306 involves edge caching the result of the S&OP simulation in an edge cache server 116 near a geographical point of origin of S&OP raw data 108.

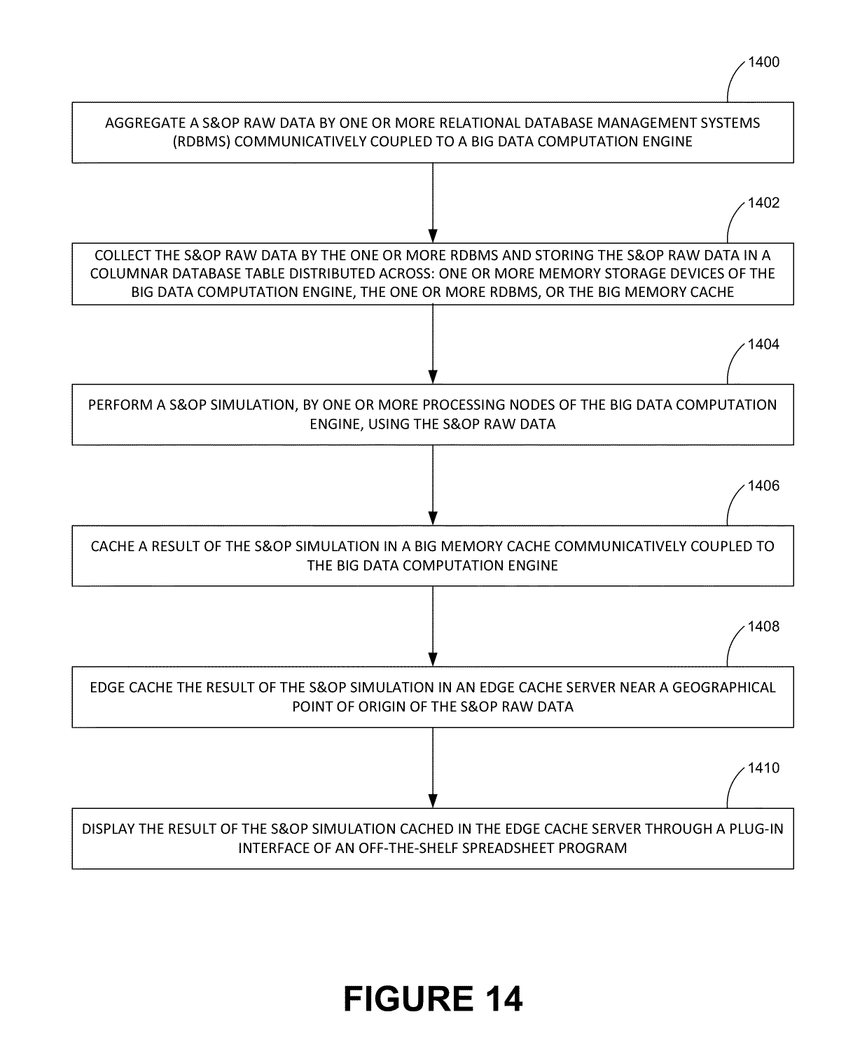

Reference is now made to FIG. 14, which is a flowchart illustrating the machine-implemented method of sales and operations planning of a business enterprise, according to one or more embodiments. FIG. 14 depicts the process flows described in FIG. 14 with additional operations for collecting and storing S&OP raw data 108, and displaying the result of the S&OP simulation. Operation 1400 involves aggregating a S&OP raw data 108 by one or more relational database management systems (RDBMS) 106A-106N communicatively coupled to a big data computation engine 100. Operation 1402 involves collecting the S&OP raw data 108 by the one or more RDBMS 106A-106N and storing the S&OP raw data 108 in a columnar database table distributed across: one or more memory storage devices of the big data computation engine 100, the one or more RDBMS 106A-106N, or the big memory cache 102. Operation 1404 involves performing a S&OP simulation, by one or more processing nodes of the big data computation engine 100, using the S&OP raw data 108. Operation 1406 involves caching a result of the S&OP simulation in a big memory cache 102 communicatively coupled to the big data computation engine 100. Operation 1408 involves edge caching the result of the S&OP simulation in an edge cache server 116 near a geographical point of origin of S&OP raw data 108. Operation 1410 involves displaying the result of the S&OP simulation cached in the edge cache server 116 through a plug-in interface 200A of an off-the-shelf spreadsheet program.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

The process flows and flow diagrams depicted in the figures do not require the particular order shown, or sequential order, to achieve desirable results. In addition, others may be provided, or steps may be eliminated from the described flows, and other components may be added to or removed from the depictions.

1. A machine-implemented method of sales and operations planning (S&OP) of a business enterprise, comprising:
aggregating a S&OP raw data by one or more relational database management systems (RDBMS) communicatively coupled to a big data computation engine,
wherein the S&OP raw data is stored in a columnar data table;
performing a S&OP simulation, by one or more processing nodes of the big data computation engine, using the S&OP raw data;
caching a result of the S&OP simulation in a big memory cache communicatively coupled to the big data computation engine; and
edge caching the result of the S&OP simulation in an edge cache server near a geographical point of origin of the S&OP raw data,
wherein the S&OP raw data is a historical or forward-looking data input from at least one of an enterprise resource planning (ERP) program, a customer relationship management (CRM) program, a supplier relationship management (SRM) program, a material resource planning (MRP) program, a stock-keeping unit (SKU) database, and a user client device.

2. The method of claim 1, further comprising:
displaying the result of the S&OP simulation cached in the edge cache server through a plug-in interface of an off-the-shelf spreadsheet program.

3. The method of claim 2, further comprising:
displaying the result of the S&OP simulation cached in the edge cache server through a web based spreadsheet program.

4. The method of claim 3, wherein the edge caching of the result of the S&OP simulation is accelerated by a toll route of data transmission.

5. The method of claim 4, further comprising:
collecting the S&OP raw data by the one or more storage devices of the big data computation engine and the one or more RDBMS and storing the S&OP raw data in a columnar database table distributed across: one or more memory storage devices of the big data computation engine, the one or more RDBMS, or the big memory cache.

6. The method of claim 5, wherein the S&OP simulation comprises:
modeling a historical or forward-looking profitability of the business enterprise using the S&OP raw data;
modeling a demand and supply plan of the business enterprise using the S&OP raw data;
modeling a capacity constraint of the business enterprise using the S&OP raw data;
modeling a new product introduction by the business enterprise using the S&OP raw data; and
extrapolating at least one of a weekly, a multi-week, a monthly, a multi-month, a yearly, and a multi-year financial forecast of the business enterprise using the S&OP raw data.

7. The method of claim 6, wherein the S&OP simulation further comprises balancing a demand criteria, a supply criteria, and a finance criteria of the business enterprise using the S&OP raw data.

8. The method of claim 7, wherein the S&OP simulation further comprises:
modeling a what-if scenario at a demand forecasting stage and a supply forecasting stage of the business enterprise using the S&OP raw data; and
modeling a financial scenario at a demand forecasting stage and a supply forecasting stage of the business enterprise using the S&OP raw data.

9. A sales and operations planning (S&OP) system of a business enterprise comprising:
one or more relational database management systems (RDBMS) to aggregate a S&OP raw data,
wherein the S&OP raw data is stored in a columnar data table;
a big data computation engine communicatively coupled to the one or more RDBMS;
one or more processing nodes of the big data computation engine to perform a S&OP simulation using the S&OP raw data;
a big memory cache, communicatively coupled to the big data computation engine, to cache a result of the S&OP simulation; and
an edge cache server near a geographical point of origin of the S&OP raw data to edge cache the result of the S&OP simulation,
wherein the S&OP raw data is a historical or forward-looking data input from at least one of an enterprise resource planning (ERP) program, a customer relationship management (CRM) program, a supplier relationship management (SRM) program, a material resource planning (MRP) program, a stock-keeping unit (SKU) database, and a user client device.

10. The system of claim 9, wherein the result of the S&OP simulation cached in the edge cache server is displayed through a plug-in interface of an off-the-shelf spreadsheet program.

11. The system of claim 10, wherein the result of the S&OP simulation cached in the edge cache server is displayed through a web based spreadsheet program.

12. The system of claim 11, wherein the edge caching of the result of the S&OP simulation is accelerated by a toll route of data transmission.

13. The system of claim 12, wherein the one or more storage devices of the big data computation engine and the one or more RDBMS collects the S&OP raw data and stores the S&OP raw data in a columnar database table distributed across: one or more memory storage devices of the big data computation engine, the one or more RDBMS, or the big memory cache.

14. The system of claim 13, wherein the S&OP simulation comprises:
modeling a historical or forward-looking profitability of the business enterprise using the S&OP raw data;
modeling a demand and supply plan of the business enterprise using the S&OP raw data;
modeling a capacity constraint of the business enterprise using the S&OP raw data;
modeling a new product introduction by the business enterprise using the S&OP raw data; and
extrapolating at least one of a weekly, a multi-week, a monthly, a multi-month, a yearly, and a multi-year financial forecast of the business enterprise using the S&OP raw data.

15. The system of claim 14, wherein the S&OP simulation further comprises balancing a demand criteria, a supply criteria, and a finance criteria of the business enterprise using the S&OP raw data.

16. The system of claim 15, wherein the S&OP simulation further comprises:
modeling a what-if scenario at a demand forecasting stage and a supply forecasting stage of the business enterprise using the S&OP raw data; and
modeling a financial scenario at a demand forecasting stage and a supply forecasting stage of the business enterprise using the S&OP raw data.

17. A non-transitory medium, readable through one or more processing nodes of a big data computation engine and including instructions embodied therein that are executable through the one or more processing nodes, comprising:
instructions to aggregate a S&OP raw data by one or more relational database management systems (RDBMS) communicatively coupled to the big data computation engine,
wherein the S&OP raw data is stored in a columnar data table;
instructions to perform a S&OP simulation, by the one or more processing nodes of the big data computation engine, using the S&OP raw data;
instructions to cache a result of the S&OP simulation in a big memory cache communicatively coupled to the big data computation engine; and
instructions to edge cache the result of the S&OP simulation in an edge cache server near a geographical point of origin of the S&OP raw data,
wherein the S&OP raw data is a historical or forward-looking data input from at least one of an enterprise resource planning (ERP) program, a customer relationship management (CRM) program, a supplier relationship management (SRM) program, a material resource planning (MRP) program, a stock-keeping unit (SKU) database, and a user client device.

18. The non-transitory medium of claim 17, further comprising:
instructions to display the result of the S&OP simulation cached in the edge cache server through a plug-in interface of an off-the-shelf spreadsheet program

19. The non-transitory medium of claim 18, further comprising:
instructions to display the result of the S&OP simulation cached in the edge cache server through a web based spreadsheet program.

20. The non-transitory medium of claim 19, further comprising:
instructions to collect the S&OP raw data by the one or more memory storage devices of the big data computation engine and the one or more RDBMS and storing the S&OP raw data in a columnar database table distributed across: one or more memory storage devices of the big data computation engine, the one or more RDBMS, or the big memory cache.
